(19) United States
(12) Patent Application Publication
(10) Pub. No.: US 2022/0276193 A1
(43) Pub. Date: Sep. 1, 2022

(54) Analysis Device and Method

(71) Applicant: Nippon Telegraph and Telephone Corporation, Tokyo (JP)

(72) Inventors: Kenta Fukada, Tokyo (JP); Yuzuru Iwasaki, Tokyo (JP); Suzuyo Inoue, Musashino-shi (JP); Michiko Seyama, Tokyo (JP)

(21) Appl. No.: 17/624,770

(22) PCT Filed: Jul. 5, 2019
(86) PCT No.: PCT/JP2019/026820

§ 371 Date: Jan. 4, 2022

(51) Int. Cl. G01N 27/27; G01N 27/403; G01N 21/552

(52) U.S. Cl. CPC G01N 27/27; G01N 27/403; G01N 21/553

(57) ABSTRACT

In a flow channel in a measurement region, there are placed a first working electrode, a second working electrode, a third working electrode, a counter electrode, and a reference electrode. The first working electrode, the second working electrode, and the third working electrode are made of a metal such as gold and are formed on a first wall surface of the flow channel. The counter electrode is formed on a second wall surface of the flow channel that faces the first wall surface. The reference electrode is placed on the second wall surface, not in contact with the first working electrode, the second working electrode, and the third working electrode. Surface plasmon resonance measurement is performed at the first working electrode, the second working electrode, and the third working electrode.

### CROSS-REFERENCE TO RELATED APPLICATION

This application is a national phase entry of PCT Application No. PCT/JP2019/026820, filed on Jul. 5, 2019, which application is hereby incorporated herein by reference.

### TECHNICAL FIELD

The invention relates to an analysis device and an analysis method with a flow cell and the like.

### BACKGROUND

Measurement using a sophisticated biomolecule identification function, such as an antigen-antibody reaction, an enzymatic reaction, and bonding of a DNA fragment (DNA probe) to DNA, is becoming an important technique in clinical testing, biochemical measurement, and measurement for environmental pollutants. This type of measurement includes micro-TAS (Total Analysis Systems), micro-combinatory chemistry, chemical ICs, chemical sensors, biosensors, microanalysis, electrochemical analysis, quartz crystal microbalance measurement, and surface plasmon (SPR) resonance measurement, for example. In the field of such measurement, an analyte to be measured is scarce and not easy to collect, and thus the amount of the analyte available for measurement is often very small.

In the above-mentioned measurement, it is needed to develop a technique in which a very small amount of analyte solution is directly transferred to a measurement unit to analyze it with higher sensitivity and higher efficiency without decreasing the concentration of the analyte. For example, a measurement technique with a flow cell having a minute flow channel has been developed. In addition, as a technique enabling the transfer of a very small amount of solution, a technique has been proposed in which a region having a plurality of patterns formed therein by a micro-processing technique is provided and a liquid in a flow cell is transferred by a capillary pump using the capillary phenomenon in this region (Patent Literature 1).

### CITATION LIST

### Patent Literature

Patent Literature 1: International Publication No. WO 2009/096527

### SUMMARY

### Technical Problem

However, a problem that has been associated with the above-mentioned conventional technique is that surface plasmon resonance (SPR) measurement is used as the analysis method, and therefore, when a reaction in which chemical bonding or physical adsorption is less likely to occur, such as an enzymatic reaction and a catalytic reaction, is subjected to the analysis, the change in refractive index due to the bonding or adsorption of a substance may be small and such analysis is not easy.

To solve this problem, noticing the fact that a reaction system involving electron transfer may be utilized even in a reaction in which bonding or adsorption is less likely to occur, it has been studied to combine electrochemical measurement with SPR measurement.

The electrochemical measurement is now described with reference to FIG. 11. In the electrochemical measurement, a reaction between a working electrode 401 and a counter electrode 402 in an analyte solution 403 is measured. In the analyte solution 403, a reference electrode, which is not illustrated, is provided in a contact manner. In this type of electrochemical measurement, for example, a voltage is applied between the working electrode 401 and the counter electrode 402, and a potential between the working electrode 401 and the reference electrode is controlled to be a predetermined potential. In this state, an electric current flowing between the working electrode 401 and the counter electrode 402 is measured. Alternatively, constant electric current control may be optionally applied between the working electrode 401 and the counter electrode 402, and in this state, a potential between the working electrode 401 and the reference electrode may be measured.

A reaction between a substrate 404 and an oxidation-type enzyme 405 in the analyte solution 403 generates a product containing hydrogen peroxide (H₂O₂) via an enzyme-substrate complex. With this product, a reduction-oxidation reaction is promoted by the oxidation-type enzyme 405 and a reduction-type enzyme 406, and the resulting electric current value is observed with the working electrode 401 and the counter electrode 402. In addition, a reduction-oxidation state in mediators 407, 408 mediating electrons is controlled, for example, through control of the potentials of the working electrode 401, the counter electrode 402, and the reference electrode, to control the reaction between the substrate 404 and the enzyme 405, and thereby precise measurement can be achieved.

However, as described below, it is difficult to simply combine the electrochemical measurement with the flow cell-type SPR measurement. The reason is that air bubbles may enter the flow cell during liquid transfer and that performing the electrochemical measurement without taking any measures against such a situation may lead to failure in the electrodes. Specifically, in the measurement with the flow cell, the fresh analyte solution is sequentially transferred into the flow channel of the flow cell, and, for example, due to the bubbling of the analyte solution itself or the ingress of gases from a connection point of a liquid transfer tube, air bubbles may enter the flow channel.

When the electrochemical measurement is combined with the flow cell-type measurement, the working electrode, the counter electrode, and the reference electrode are placed in the flow channel in which the analyte solution flows, and a potential difference is generated between the working electrode and the counter electrode, for example. When air bubbles approach the electrode such as the working electrode and the counter electrode in the flow channel in which the analyte solution is flowing, an electric field is concentrated at the air bubbles having a low dielectric constant and the high electric field is applied to the interfaces between the air bubbles on the electrode and the solution. Consequently, the metal may melt out, which may lead to failure in the electrode. As described above, reliable analysis is impossible in a condition where the electrode is damaged.

An object of embodiments of the present invention, which has been made to solve the above-mentioned problems, is to achieve reliable analysis in which the electrochemical measurement is combined with the flow cell-type SPR measurement.

### Means for Solving the Problem

An analysis device according to an embodiment of the present invention includes: an introduction port allowing introduction of a liquid to be measured; a flow channel that has one end connected to the introduction port and allows transfer of the liquid; a measurement region provided in a part of the flow channel; a working electrode made of a metal and formed on a first wall surface of the measurement region; a counter electrode formed on a second wall surface of the measurement region that faces the first wall surface; a reference electrode formed on a wall surface of the measurement region; an electrochemical measurement unit configured to perform electrochemical measurement with the working electrode, the counter electrode, and the reference electrode; and a surface plasmon measurement unit configured to perform surface plasmon resonance measurement at the working electrode.

An analysis method according to an embodiment of the present invention, using an analysis device, which includes: an introduction port allowing introduction of a liquid to be measured; a flow channel that has one end connected to the introduction port and allows transfer of the liquid; a measurement region provided in a part of the flow channel; a working electrode made of a metal and formed on a first wall surface of the measurement region; a counter electrode formed on a second wall surface of the measurement region that faces the first wall surface; a reference electrode formed on a wall surface of the measurement region; an electrochemical measurement unit with the working electrode, the counter electrode, and the reference electrode; and a surface plasmon measurement unit configured to perform surface plasmon resonance measurement at the working electrode, the method includes: a first step in which the surface plasmon resonance measurement of the liquid to be measured that has been introduced from the introduction port and is being transferred in the flow channel is performed; and a second step in which when a change in which the refractive index of air is observable is measured in the surface plasmon resonance measurement, electrochemical measurement of the liquid is suspended.

### Effects of Embodiments of the Invention

As described above, according to embodiments of the present invention, reliable analysis in which the electrochemical measurement is combined with the flow cell-type SPR measurement can be achieved.

### BRIEF DESCRIPTION OF THE DRAWINGS

FIG. 1 is a perspective view showing a configuration of an analysis device according to a first embodiment of the present invention.

FIG. 2 is a cross-sectional view showing a partial configuration of the analysis device according to the first embodiment of the present invention.

FIG. 3 is a configuration diagram showing a configuration of the analysis device according to the first embodiment of the present invention.

FIG. 4 is an explanatory diagram showing a simulation result regarding the strength and direction of the electric fields between respective working electrodes and a counter electrode in a flow channel.

FIG. 5A is a perspective view illustrating the manufacture of a cell structure of the analysis device according to the first embodiment of the present invention.

FIG. 5B is a perspective view illustrating the manufacture of the cell structure of the analysis device according to the first embodiment of the present invention.

FIG. 5C is a perspective view illustrating the manufacture of the cell structure of the analysis device according to the first embodiment of the present invention.

FIG. 6A is a flowchart for illustrating an analysis method according to the first embodiment of the present invention.

FIG. 6B is a configuration diagram showing a hardware configuration of a determination unit.

FIG. 7 is a perspective view showing a configuration of a cell structure of an analysis device according to a second embodiment of the present invention.

FIG. 8 is a plan view showing a partial configuration of the cell structure of the analysis device according to the second embodiment of the present invention.

FIG. 9 is an explanatory diagram showing a simulation result regarding the strength and direction of the electric fields between respective working electrodes and a counter electrode in a flow channel and a flow channel.

FIG. 10 is an explanatory diagram showing a simulation result of flow velocity for a plurality of flow channels with the flow directions parallel to each other.

FIG. 11 is an explanatory diagram illustrating an analysis using a biomolecule identification function with electrochemical measurement.

### DETAILED DESCRIPTION OF ILLUSTRATIVE EMBODIMENTS

Analysis devices according to embodiments of the present invention will be described below.

### First Embodiment

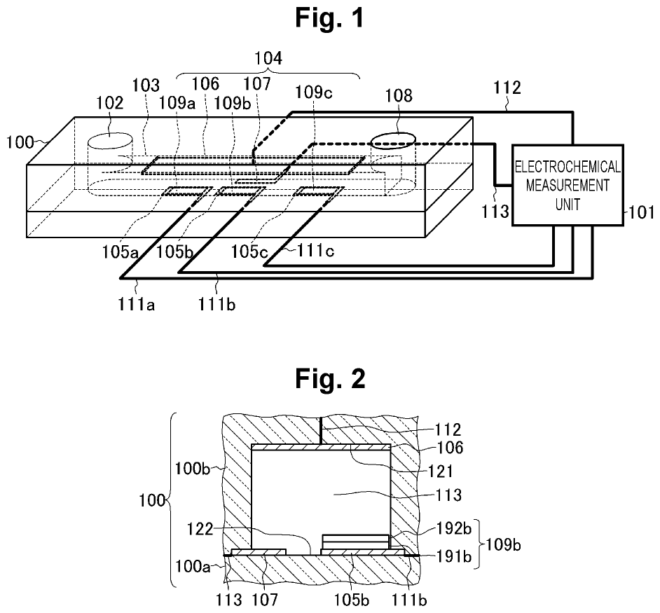

First, an analysis device according to a first embodiment of the present invention is described with reference to FIG. 1 and FIG. 2. The analysis device includes a cell structure 100, an electrochemical measurement unit 101, and a surface plasmon measurement unit (not illustrated).

The cell structure 100 includes an introduction port 102 allowing introduction of a liquid to be measured, a flow channel 103 that has one end connected to the introduction port 102 and allows transfer of the liquid, and a measurement region 104 provided in a part of the flow channel 103. A discharge port 108 is formed at the other end of the flow channel 103. A suction pump (not illustrated), for example, is connected to the discharge port 108 so that an analyte solution supplied to the introduction port 102 can be transferred to the flow channel 103. The flow channel 103 is formed to have a width of 1 mm and a height of about 10 to 100 m in the cross-sectional view. A suction flow channel may be provided at the other end of the flow channel 103 so that the suction flow channel may be used as a suction pump. The suction flow channel has a plurality of through-holes that reach the suction flow channel and functions as a suction pump with the capillary phenomenon of the through-holes.

In the flow channel 103 in the measurement region 104, there are placed a working electrode 105a, a working electrode 105b, a working electrode 105c, a counter electrode 106, and a reference electrode 107. The working electrodes 105a, 105b, 105c are made of a metal such as gold (Au) and are formed on a first wall surface 121 of the flow channel 103. The counter electrode 106 is formed on a second wall surface 122 of the flow channel 103 that faces the first wall surface 121. The cell structure 100 is generally placed so that the second wall surface 122 is located on the ground-side. The reference electrode 107 is formed on any wall surface of the measurement region 104. For example, the reference electrode 107 is placed on the second wall surface 122, not in contact with the working electrodes 105a, 105b, 105c.

On the working electrodes 105a, 105b, 105c, functional layers 109a, 109b, 109c are formed. For example, the functional layer 109b is composed of an enzyme immobilization layer 191b on the working electrode 105b-side and a mediator layer 192b formed on the enzyme immobilization layer 191b, as shown in FIG. 2. The functional layers 109a, 109c are similar to the functional layer 109b. The functional layers are each composed of different enzyme-immobilized layers and mediator layers.

The cell structure 100 has a configuration in which a support base 100a and a flow channel base 100b with a groove-forming portion serving as the flow channel 103 are bonded together. The support base 100a can be made of a transparent material such as glass. The flow channel base 100b can be made of hydrophilic polydimethylsiloxane, for example.

The cell structure 100 also includes first lead wirings 111a, 111b, 111c, a second lead wiring 112, and a third lead wiring 113.

The first lead wirings 111a, 111b, 111c are respectively connected to the working electrodes 105a, 105b, 105c, and are drawn out through the cell structure 100 on the side perpendicular to the first wall surface 121 to connect to the electrochemical measurement unit 101. The electrochemical measurement unit 101 is a potentiostat, for example. The second lead wiring 112 is connected to the counter electrode 106 and is drawn out through the cell structure 100 on the second wall surface 122-side to connect to the electrochemical measurement unit 101. The third lead wiring 113 is connected to the reference electrode 107 and is drawn out through the cell structure 100 on the side perpendicular to the first wall surface 121 to connect to the electrochemical measurement unit 101.

As described above, placing the lead wirings does not prevent the SPR measurement described later and does not block the flow channel 103. The reference electrode 107 is placed as close to the working electrodes 105a, 105b, 105c as possible. The single counter electrode 106 may be used for a plurality of working electrodes 105a, 105b, 105c to perform the electrochemical measurement.

The electrochemical measurement unit 101 performs the electrochemical measurement with the working electrodes 105a, 105b, 105c, the counter electrode 106, and the reference electrode 107. The surface plasmon measurement unit performs the surface plasmon resonance measurement at the working electrodes 105a, 105b, 105c.

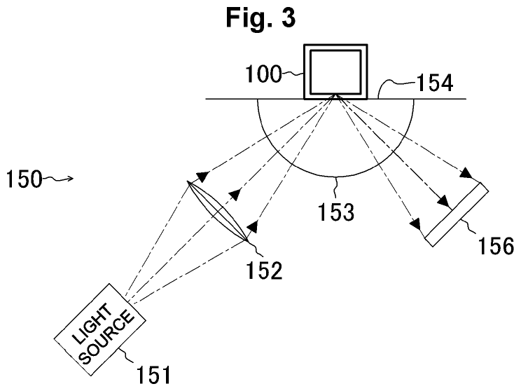

The surface plasmon measurement unit is now described with reference to FIG. 3. The surface plasmon measurement unit is composed of a surface plasmon measurement device 150. The surface plasmon measurement device 150 includes a light source 151 consisted of a light-emitting diode and the like, a prism 153, and an optical measurement section 156.

First, the cell structure 100 is placed on a measurement surface 154 of the surface plasmon measurement device 150. Matching oil is applied between the measurement surface 154 of the prism 153 and the mounting surface of the cell structure 100, and the cell structure 100 is mounted so that the measurement region overlaps the optical axis of the light from the light source 151.

In this measurement, the light emitted from the light source 151 is condensed by an incident-side lens 152 to enter the prism 153 and is then applied to the measurement region of the cell structure 100 in close contact with the measurement surface 154 of the prism 153. The measurement region of the cell structure 100 has the working electrode made of a metal (for example, Au) formed therein, and the condensed light passed through the support base 100a of the cell structure 100 is applied to the back surface of the working electrode in a condition where the analyte liquid is flowing on the surface of the working electrode. The condensed light, which has been applied in this way, is reflected on the back surface of the working electrode, and then the intensity (light intensity) is measured by the optical measurement section 156 composed of an image sensor such as a so-called CCD image sensor. In this measurement, a valley indicating a low reflectance is observed, for example, at an angle that the resonance between an evanescent wave and a surface plasmon wave occurs on the surface of the working electrode.

In the surface plasmon resonance measurement, data reflecting the refractive index is observed for each line in the x direction of the CCD image sensor, for example. Therefore, as the liquid to be measured proceeds in the flow channel in the measurement region, the above-mentioned change in the refractive index occurs in this process, and the timing the change in the refractive index occurs due to the proceeding liquid is recorded for each line of the CCD image sensor. As the surface plasmon measurement device 150, “SMART SPR: NTT Advanced Technology Corporation” can be used, for example.

In the analysis device according to the first embodiment, first, a product such as hydrogen peroxide is generated from a substrate existing in the analyte liquid being transferred in the flow channel 103 and an enzyme in the enzyme immobilization layer. The product promotes reduction/oxidation in the mediator layer, resulting in an electric current to be extracted. Through this series of reactions, factors such as a change of the substance in the mediator layer and adhesion of an enzyme-substrate complex cause a change in the refractive index of the analyte solution on the working electrode.

The above-mentioned condition of the analyte liquid being transferred in the flow channel 103 is measured simultaneously by the electrochemical measurement unit 101 and the surface plasmon measurement device 150. When the change in the refractive index of the analyte liquid on the working electrode is large enough to be observed by the surface plasmon measurement device 150, the SPR measurement is possible.

In addition, the electric current generated by the above-mentioned enzymatic reaction is also measured by the electrochemical measurement unit 101 at the same time. In the electrochemical measurement by the electrochemical measurement unit 101 with the working electrodes 105a, 105b, 105c, the counter electrode 106, and the reference electrode 107, the reduction/oxidation condition in the mediator layer is also controlled, and combining the electrochemical measurement and the SPR measurement enables more precise measurement. For example, voltages are applied between the respective working electrodes 105a, 105b, 105c and the counter electrode 106, and potentials between the respective working electrodes 105a, 105b, 105c and the reference electrode 107 are controlled to be predetermined potentials. In this state, the electric currents flowing between the respective working electrodes 105a, 105b, 105c and the counter electrode 106 are measured.

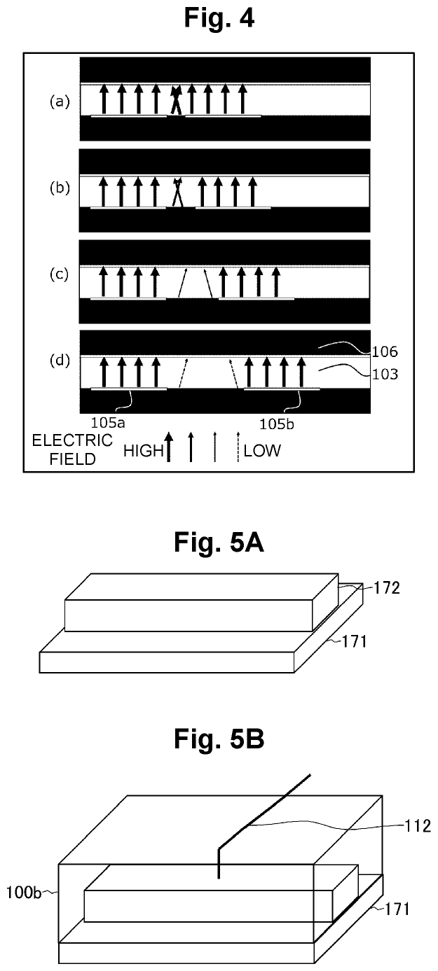

Next, a simulation result regarding the strength and direction of the electric fields between the respective working electrodes and the counter electrode 106 in the flow channel 103 is described with reference to FIG. 4. FIG. 4 shows a state of the flow channel 103 in the liquid transfer direction viewed from the lateral direction. This simulation represents the flow channel 103 filled with water between two working electrodes 105a, 105b and one counter electrode 106. FIG. 4 shows a result regarding the strength and direction of the electric fields when the same potential differences are generated between the respective working electrodes and the counter electrode. As shown with the arrow lines, the electric fields are directed from the working electrodes 105a, 105b to the counter electrode 106. Further, as shown in (a), (b), (c), and (d) of FIG. 4, the distance between the two working electrodes 105a, 105b is changed to examine the optimum arrangement of the electrodes.

When the liquid in the flow channel 103 is pure water and can be regarded as a dielectric, it is understood that the adjacent electrodes need to be placed apart enough so that the electric fields from the respective electrodes do not affect each other. Instead of performing the electrochemical measurement with all of a plurality of working electrodes at a time, arranging alternately the working electrode performing only the SPR measurement and the working electrode performing the SPR and the electrochemical measurement allows the effect of the electric fields from the adjacent electrodes to be neglected.

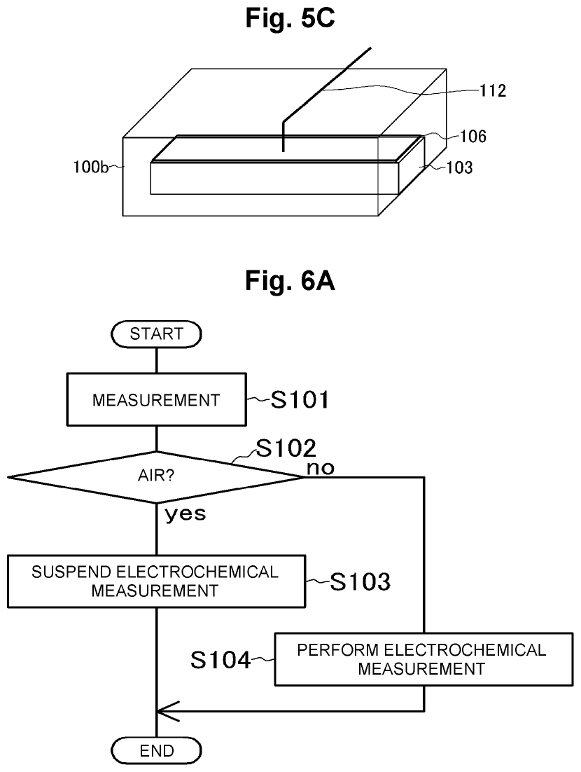

Next, the manufacture of the cell structure 100 is briefly described. First, as illustrated in FIG. 5A, a mold base 171 is prepared. A flow channel mold 172 is formed on the mold base 171. The mold base 171 is, for example, a silicon wafer. The flow channel mold 172 can consist of a resist pattern formed with a photolithography technique.

Next, as illustrated in FIG. 5B, hydrophilic polydimethylsiloxane (PDMS) film is formed (applied) so as to cover the upper surface and the side surfaces of the flow channel mold 172. After the PDMS film is formed, it is heated at 80° C. for 120 minutes for hardening (solidification), and thereby a flow channel base 100b is formed. The hydrophilic PDMS is prepared by adding 1% by weight of trisiloxane ethoxylate (e.g., SILWET L-77), which is a polyether-modified silicone, to the not-yet-solidified hydrophobic PDMS and performing vacuum defoaming. The not-yet-solidified hydrophobic PDMS to be used can be prepared by mixing a PDMS base (e.g., SYLGARD 184) and a polymerization initiator at a ratio of 10:1 and performing vacuum defoaming. Before forming the PDMS film, the second lead wiring 112, for example, is placed at a predetermined position in the flow channel mold 172. When the PDMS film is formed in this state, the second lead wiring 112 is incorporated in the flow channel base 100b.

Next, the flow channel base 100b is separated from the mold base 171, and then the counter electrode 106 is formed in the flow channel 103 as illustrated in FIG. 5C. The counter electrode 106 is electrically bonded with a conductive paste and the like to prevent it from coming off. The second lead wiring 112 drawn out from the flow channel base 100b is connected to the electrochemical measurement unit 101.

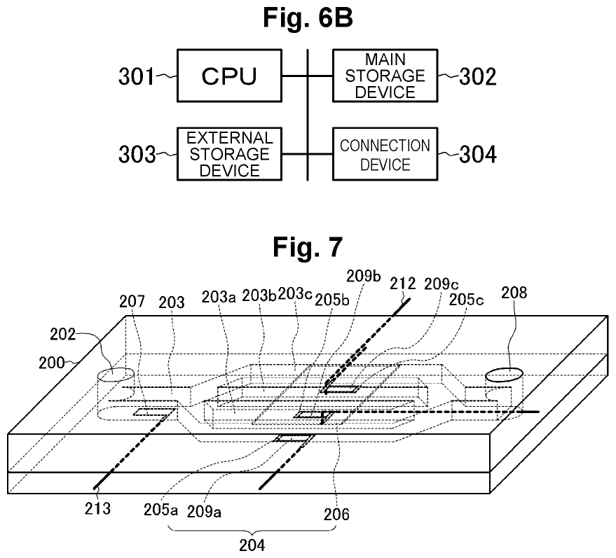

In transferring the liquid, air bubbles may enter the flow channel 103. When the air bubbles pass through the electrode at which the electrochemical measurement is performed, failure in the electrode may occur as described above. An analysis method according to the first embodiment that prevents the failure in the electrode due to the inclusion of air bubbles is described with reference to FIG. 6A.

First, in a first step S101, the surface plasmon resonance measurement of the liquid to be measured that has introduced from the introduction port 102 and is being transferred in the flow channel 103 is performed at the working electrode 105a by the surface plasmon measurement device 150. Next, in a second step S102, it is determined whether a change in which the refractive index of air is observable has been measured with the surface plasmon measurement described above.

For example, a determination unit (not illustrated) determines whether a change in which the refractive index of air is observable has been measured by the surface plasmon measurement unit. For example, the determination unit acquires the refractive index measured by the surface plasmon measurement unit and determines whether the refractive index of air set in the determination unit corresponds to the acquired refractive index.

When a change in which the refractive index of air is observable is measured by the surface plasmon measurement unit, the determination unit determines that air bubbles are included in the measurement region (yes in step S102). For example, when, in the determination unit, the refractive index acquired by the surface plasmon measurement unit corresponds to the refractive index of air set in the determination unit, the determination unit determines that air bubbles are included in the measurement region.

When the inclusion of air bubbles is determined (e.g., confirmed) as described above, the electrochemical measurement unit suspends the electrochemical measurement in a third step S103, for example, prevents the electric current from flowing to the working electrode. For example, by suspending the operation of the electrochemical measurement unit 101, the supply of the electric current to the working electrode is suspended. Alternatively, for example, the determination unit, which determines that air bubbles are included in the measurement region, controls the operation of the electrochemical measurement unit 101 to suspend the supply of the electric current to the working electrode.

On the other hand, when a change in which the refractive index of air is observable is not measured by the surface plasmon measuring unit (no in step S102), the electrochemical measurement is performed in step S104. For example, when the refractive index acquired by the surface plasmon measurement unit does not correspond to the refractive index of air set in the determination unit, the determination unit determines that air bubbles are not included in the measurement region. According to the determination result of the determination unit, the electrochemical measurement is allowed to be performed. When the determination unit determines that air bubbles are not included in the measurement region, the measurement operation by the electrochemical measurement unit 101 is not suspended (for example, the supply of the electric current to the working electrode is not suspended), and thus the electrochemical measurement is performed by the electrochemical measurement unit 101.

According to the above-mentioned measurement method, when air bubbles are included, for example, the electric current is not applied to the working electrode, and when the inclusion of air bubbles is eliminated, the electric current can be applied to the working electrode to restart the electrochemical measurement.

The above-mentioned determination unit, as illustrated in FIG. 6B, may be a computer apparatus including, for example, a CPU (Central Processing Unit) 301, a main storage device 302, an external storage device 303, and a connection device 304, and the above-mentioned function of the determination unit may be also achieved through the operation (execution of a program) of the CPU 301 based on the program derived in the main storage device. The program is intended to make the computer execute the operation analysis process of the determination unit according to the embodiment described above. The connection device 304 is connected to the electrochemical measurement unit and the surface plasmon measurement unit.

### Second Embodiment

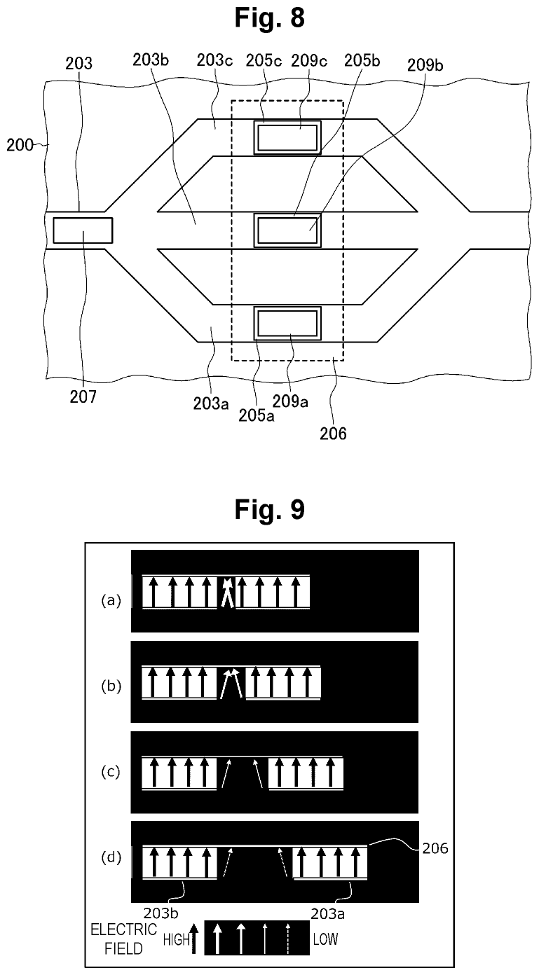

Next, an analysis device according to a second embodiment of the present invention is described. A cell structure 200 of the analysis device is described with reference to FIG. 7 and FIG. 8 below. The cell structure 200 includes a plurality of flow channels 203a, 203b, 203C in a measurement region 204. The plurality of flow channels 203a, 203b, 203c have the flow directions parallel to each other.

The cell structure 200 includes an introduction port 202 allowing introduction of a liquid to be measured, an introduction flow channel 203 connected to the introduction port 202, the plurality of flow channels 203a, 203b, 203c branching from the introduction flow channel 203, and the measurement region 204 provided in parts of the flow channels 203a, 203b, 203c. A discharge port 208 is formed at other ends of the flow channels 203a, 203b, 203c. A suction pump (not illustrated), for example, is connected to the discharge port 208 so that an analyte solution supplied to the introduction port 202 can be transferred to the flow channels 203a, 203b, 203c. A suction flow channel may be provided at the other ends of the flow channels 203a, 203b, 203c so that the suction flow channel may be used as a suction pump.

In the flow channels 203a, 203b, 203c in the measurement region 204, there are placed a working electrode 205a, a working electrode 205b, a working electrode 205c, a counter electrode 206, and a reference electrode 207. The working electrodes 205a, 205b, 205c are made of a metal such as Au and are respectively formed on first wall surfaces of the flow channels 203a, 203b, 203c. The counter electrode 206 is formed on second wall surfaces of the flow channels 203a, 203b, 203c that face the first wall surfaces. The cell structure 200 is generally placed so that the second wall surfaces are located on the ground-side. The counter electrode 206 is provided to be common to the working electrodes 205a, 205b, 205c and is formed over the flow channels 203a, 203b, 203c. The reference electrode 207 is formed on any wall surface of the measurement region 204. For example, the reference electrode 207 is placed on a wall surface of the introduction flow channel 203.

On the working electrodes 205a, 205b, 205c, functional layers 209a, 209b, 209c are formed. For example, the functional layer 209b is composed of an enzyme immobilization layer on the working electrode 205b-side and a mediator layer formed on the enzyme immobilization layer, as shown in FIG. 2. The functional layers 209a, 209c are similar to the functional layer 209b.

The cell structure 200 also includes first lead wirings 211a, 211b, 211c, a second lead wiring 212, and a third lead wiring 213.

The first lead wirings 211a, 211b, 211c are respectively connected to the working electrodes 205a, 205b, 205c, and drawn out through the cell structure 200 on the side perpendicular to the first wall surfaces to connect to the electrochemical measurement unit (not illustrated). The second lead wiring 212 is connected to the counter electrode 206 and is drawn out through the cell structure 200 on the second wall surface-side to connect to the electrochemical measurement unit. The third lead wiring 213 is connected to the reference electrode 207 and is drawn out through the cell structure 200 on the side perpendicular to the first wall surfaces to connect to the electrochemical measurement unit.

In the second embodiment, the working electrodes on each of which the functional layer with the enzyme immobilization layer is formed are placed in the different flow channels. Therefore, a product generated on any working electrode does not affect the analysis (e.g., measurement) at other working electrodes.

In an arrangement with a plurality of working electrodes in one flow channel, when a product is generated by an enzymatic reaction or a catalytic reaction at the former working electrode, it may affect the measurement at the latter working electrode. When the diffusion of the product generated by the enzymatic reaction or the catalytic reaction is low, or when the flow velocity is low or the flow may be still, such arrangement, with a plurality of working electrodes in one flow channel, may not cause the above-mentioned problem. However, when the product affects the measurement at other working electrodes, the problem of the effect of the product is prevented with the configuration in which a plurality of flow channels are provided and one working electrode is placed in each flow channel, as in the second embodiment.

Next, a simulation result regarding the strength and direction of the electric fields between the respective working electrodes and the counter electrode 206 in the flow channels 203a, 203b is described with reference to FIG. 9. FIG. 9 shows a state of the flow channels 203a, 203b viewed in a cross-section perpendicular to the flow directions. This simulation represents a state in which the flow channels 203a, 203b are filled with water. FIG. 9 shows a result regarding the strength and direction of the electric fields when the same potential differences are generated between the respective working electrodes and the counter electrode 206. As shown with the arrow lines, the electric fields are directed from the working electrodes of the respective flow channels to the counter electrode 206. Further, as shown in (a), (b), (c), and (d) of FIG. 9, the distance between the two flow channels 203a, 203b is changed to examine the optimum arrangement of the electrodes.

When the liquid in the flow channels 203a, 203b is pure water and can be regarded as a dielectric, it is understood that the electrodes in the adjacent flow channels 203a, 203b need to be placed apart enough so that the electric fields from the respective electrodes do not affect each other.

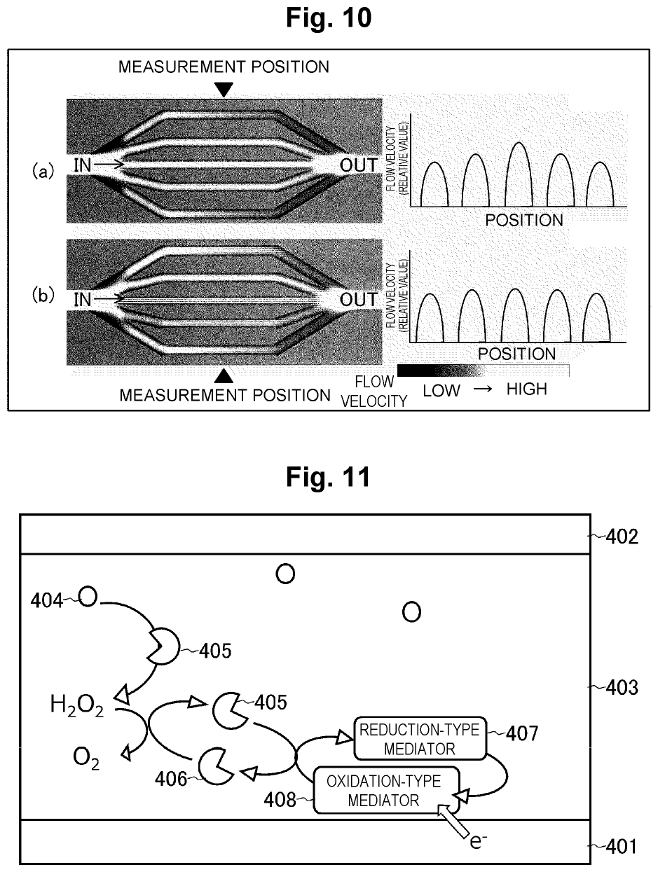

Next, the flow velocity is described. For a plurality of flow channels with the flow directions parallel to each other, making the branched flow channels have the same flow velocities enables the SPR measurement and the electrochemical measurement under the same conditions. As shown in the simulation result in (a) of FIG. 10, the constant widths of the flow channels provide different flow velocities to the respective branched flow channels. The reason is that, in the straight portion of the flow channel before branching, the flow velocity increases closer to the center.

On the other hand, the flow channel connected to a portion closer to the center of the flow channel before branching has a smaller width, and the flow channel connected to a portion further from the center of the flow channel before branching has a larger width. Such a configuration can provide the same flow velocities to the respective flow channels, as shown in the simulation result in (b) of FIG. 10.

As described above, according to embodiments of the present invention, the surface plasmon resonance measurement is performed at the working electrode for the electrochemical measurement that is placed in the flow channel allowing transfer of the liquid to be measured. Consequently, reliable analysis in which the electrochemical measurement is combined with the flow cell-type SPR measurement can be achieved. According to embodiments of the present invention, making the best use of the flow cell and placing a plurality of working electrodes each having different enzyme immobilization layer can achieve the multi-measurement technique for measuring a plurality of substrates in the analyte solution. Further, according to embodiments of the present invention, in the SPR measurement with the working electrode, the working electrode can detect air bubbles passing through a region, and therefore, failure in the electrode due to the inclusion of air bubbles can be prevented in the electrochemical measurement.

It will be apparent that the present invention is not limited to the embodiments described above, and that many modifications and combinations can be made by those ordinary skilled in the art within the scope of the technical ideas of the present invention.

### REFERENCE SIGNS LIST

100 cell structure
100a support base
100b flow channel base
101 electrochemical measurement unit
102 introduction port
103 flow channel
104 measurement region
105a, 105b, 105c working electrode
106 counter electrode
107 reference electrode
108 discharge port
109a, 109b, 109c functional layer
111a, 111b, 111c first lead wiring
112 second lead wiring
113 third lead wiring
121 first wall surface
122 second wall surface

1.-7. (canceled)

8. An analysis device comprising:
an introduction port configured to allow introduction of a liquid to be measured;
a flow channel having a first end connected to the introduction port, the flow channel configured to allow transfer of the liquid;
a measurement region in a part of the flow channel;
a working electrode on a first wall surface of the measurement region, the working electrode comprising a metal;
a counter electrode on a second wall surface of the measurement region, the second wall surface facing the first wall surface;
a reference electrode on a wall surface of the measurement region;
an electrochemical measurer configured to perform electrochemical measurement with the working electrode, the counter electrode, and the reference electrode; and
a surface plasmon measurer configured to perform surface plasmon resonance measurement at the working electrode.

9. The analysis device of claim 8 further comprising:
a determiner configured to determine air bubbles are in the measurement region when a change in which the refractive index of air is observable is measured by the surface plasmon measurer.

10. The analysis device of claim 9, wherein the electrochemical measurer is configured to suspend the electrochemical measurement when the determiner determines that air bubbles are in the measurement region.

11. The analysis device of claim 8, wherein the flow channel is one of a plurality of flow channels each including the measurement region.

12. The analysis device of claim 8 further comprising:
a suction flow channel connected to a second end of the flow channel.

13. The analysis device of claim 8 further comprising:
a cell structure comprising the flow channel therein;
a first lead wiring connecting the working electrode to the electrochemical measurer, the first lead wiring extending through the cell structure on a first side, the first lead wiring extending in a direction perpendicular to the first wall surface;
a second lead wiring connecting the counter electrode to the electrochemical measurer, the second lead wiring extending through the cell structure, the second lead wiring extending along the second wall surface; and
a third lead wiring connecting the reference electrode to the electrochemical measurer, the third lead wiring extending through the cell structure on a second side, the second side perpendicular to the first wall surface.

14. An analysis method using an analysis device which comprises:
an introduction port configured to allow introduction of a liquid to be measured;
a flow channel having a first end connected to the introduction port, the flow channel configured to allow transfer of the liquid;
a measurement region in a part of the flow channel;
a working electrode on a first wall surface of the measurement region, the working electrode comprising a metal;
a counter electrode on a second wall surface of the measurement region, the second wall surface facing the first wall surface;
a reference electrode on a wall surface of the measurement region;
an electrochemical measurer configured to perform electrochemical measurement with the working electrode, the counter electrode, and the reference electrode; and
a surface plasmon measurer configured to perform surface plasmon resonance measurement at the working electrode,
the analysis method comprising:
performing the surface plasmon resonance measurement of the liquid to be measured that has been introduced from the introduction port and is being transferred in the flow channel; and
when a change in which the refractive index of air is observable is measured in the surface plasmon resonance measurement, suspending electrochemical measurement of the liquid.

15. An analysis method comprising:
transferring a liquid to be measured in a flow channel, the flow channel comprising a measurement region;
performing surface plasmon resonance measurement at a working electrode with a surface plasmon measurer, the working electrode disposed on a first wall surface of the measurement region, the working electrode comprising a metal;
performing electrochemical measurement with the working electrode, a counter electrode, and a reference electrode in response to determining air bubbles are not in the measurement region, the counter electrode disposed on a second wall surface of the measurement region, the second wall surface facing the first wall surface, the reference electrode disposed on the second wall surface of the measurement region; and
suspending electrochemical measurement of the liquid in response to determining air bubbles are in the measurement region.

16. The analysis method of claim 15 further comprising:
determining air bubbles are in the measurement region when a change in which the refractive index of air is observable is measured by the surface plasmon measurer.

17. The analysis method of claim 15, wherein the flow channel is one of a plurality of flow channels each including the measurement region.

18. The analysis method of claim 15, wherein performing the electrochemical measurement comprises supplying current to the working electrode.

19. The analysis method of claim 15, wherein suspending the electrochemical measurement comprises prevents current from flowing to the working electrode.
